(19) United States
(12) Patent Application Publication
(10) Pub. No.: US 2009/0309997 A1
(43) Pub. Date: Dec. 17, 2009

(54) Image Capturing Device

(75) Inventors: Alexander Hunt, Malmo (SE); Jason M. Cope, Durham, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/138,917

(22) Filed: Jun. 13, 2008

(51) Int. Cl. H04N 5/262; H04N 5/228; G06F 3/041

(52) U.S. Cl. 348/240.2; 348/222.1; 345/173; 348/240.3; 348/E05.031; 348/E05.051

(57) ABSTRACT

An image-capturing device, such as a camera or a camera-equipped wireless communication device, includes touch-sensitive user controls disposed on a housing of the device. The touch-sensitive user controls detect user movement along the controls, and allow a user to control one or more image-capturing functions of the device based on a detected direction of user movement along the touch-sensitive user controls.

### TECHNICAL FIELD

The present invention relates generally to devices that capture images, and particularly to controlling the functions of devices that capture images.

### BACKGROUND

Devices that capture digital images, such as digital cameras, are very common. They may be standalone devices, or they may be integrated with other consumer electronic devices such as cellular telephones and personal Digital Assistants (PDAs). In many cases, the devices are configured to automatically control at least some of their features and functions to provide a user with a quality image. One example would be a camera having automatic focus capability. With automatic focus, a camera can automatically obtain, and in some cases continuously maintain, the correct focus on a subject without requiring user input. Another example would be a camera that automatically controls a flash device and/or an exposure level responsive to detecting the ambient light level.

Although these types of automatic control mechanisms are useful, many users would rather adjust the camera features and functions manually. Therefore, many cameras will typically include a variety of different buttons and other controls that allow the user to control the camera. For example, many cameras have a ‘+’ and a ‘−’ button disposed on the housing to allow a user to increase and decrease zoom. Similarly, mechanical switches allow the user to manually control focus and the camera's response to various levels of light. Some cameras may require a user to navigate a displayed menu to adjust the camera's features and functions. However, the ease with which a user may manually adjust the camera functions can be improved.

### SUMMARY

The present invention provides an image-capturing device, such as a camera or a camera-equipped wireless communication device, for example, that disposes one or more touch-sensitive user controls on a housing of the device. The touch-sensitive user controls allow a user to manually control corresponding image-capturing functions available with the device. In one embodiment, for example, a first touch-sensitive user control provides the user with the ability to adjust one or both of an optical zoom and a digital zoom. A second touch-sensitive user control provides the user with the ability to adjust focus. Other image-capturing related functions, such as exposure levels, may also be controlled using an exposure level touch-sensitive user control.

The touch-sensitive user controls are disposed on a face of the housing to allow the user to easily operate the controls. In one embodiment, for example, a touch-sensitive user control may be circularly-shaped and disposed on the housing of the device such that it substantially surrounds the device's lens assembly. The user may slide or move a finger around this user control in both clockwise and counter-clockwise directions. Based on the direction of movement, the touch-sensitive user control will generate corresponding input signals to allow for the manual control the zoom of the camera. For example, for optical zoom, the controller could generate control signals responsive to the input signals to cause the lens assembly to extend from or retract into the housing. For devices that do not have such telescoping lens assemblies, the control signals may cause one or more lenses to slide axially within the housing to control optical zoom. For digital zoom, the controller could generate control signals to command an image processor to digitally increase or decrease the zoom.

In another embodiment, a touch-sensitive user control is disposed on the housing to control the focus. This user control may be, for example, formed as an elongated strip. The user may slide or move a finger back and forth along this user control to manually control the focus. Particularly, the touch-sensitive user control will generate input signals corresponding to the detected direction of movement and send them to the controller. The controller could then generate the appropriate control signals to control the focus based on the detected direction of user movement along the touch-sensitive user control.

Therefore, according to one embodiment of the present invention, an image-capturing device comprises a housing, a lens assembly, a first touch-sensitive user control disposed on the housing, and a controller communicatively connected to the first touch-sensitive user control. The first touch-sensitive user control generates input signals based on a detected direction of user movement along the first touch-sensitive user control. The controller then generates control signals to control a first image-capturing function based on the input signals.

In one embodiment, the controller is configured to increase zoom responsive to the first touch-sensitive user control detecting the user moving in a first direction, and to decrease zoom responsive to the first touch-sensitive user control detecting the user moving in a second, opposite direction.

For example, the controller may be configured to extend the lens assembly out of the housing to increase optical zoom, and to retract the lens assembly into the housing to decrease optical zoom, responsive to the input signals.

Additionally, the image-capturing device may also comprise an image processor communicatively connected to the controller. In these embodiments, the controller may be configured to increase and decrease digital zoom responsive to the first touch-sensitive user control detecting the user moving in the first and second directions, respectively.

In one embodiment, the first touch-sensitive user control generates the input signals to cause the controller to control a focus of the lens assembly responsive to detecting the user moving in a first direction, and a second, opposite direction.

In some embodiments of the present invention, the image-capturing device may also comprise a second touch-sensitive user control disposed on the housing. The second touch-sensitive user control may be configured to generate input signals based on a detected direction of user movement along the second touch-sensitive user control. The controller then generates control signals to control a second image-capturing function responsive to the input signals generated by the second-touch sensitive user control.

For example, in one embodiment, the controller may be configured to generate control signals to control a zoom function of the image-capturing device responsive to receiving input signals from the first touch-sensitive user control, and generate control signals to control a focus of the image-capturing device responsive to receiving input signals from the second touch-sensitive user control.

In another embodiment, the controller may be configured to generate control signals to control an exposure level of the image-capturing device responsive to receiving input signals from one of the first and second touch-sensitive user controls.

The first and second touch-sensitive user controls may be positioned anywhere on the housing of the image-capturing device. In one embodiment, however, the first touch-sensitive user control is formed in a substantially circular shape, and is positioned on the housing such that it substantially surrounds the lens assembly.

The first and second touch-sensitive user controls may comprise any known type of sensor that detect a user's touch. In one embodiment, however, the first and second touch-sensitive user controls comprise capacitive sensor devices. The first touch-sensitive user control may be configured to detect the user moving around the control in a clockwise direction and a counterclockwise direction. The second touch-sensitive user control may be formed as an elongated strip configured to detect the user moving back and forth along the control.

The present invention also provides methods of controlling an image-capturing function. In one embodiment, the method comprises receiving input signals indicating a detected direction of user movement along a first touch-sensitive user control disposed on a housing of an image-capturing device, and generating control signals to control a first image-capturing function based on the input signals.

In one embodiment, generating control signals comprises generating control signals to increase optical zoom responsive to the first touch-sensitive user control detecting the user moving in a first direction, and generating control signals to decrease optical zoom responsive to the first touch-sensitive user control detecting the user moving in a second, opposite direction.

In another embodiment, generating control signals comprises generating control signals to increase digital zoom responsive to the first touch-sensitive user control detecting the user moving in a first direction, and generating control signals to decrease digital zoom responsive to the first touch-sensitive user control detecting the user moving in a second, opposite direction.

In another embodiment, generating control signals comprises generating the control signals to control a focus responsive to the first touch-sensitive user control detecting the user moving in a first direction and a second, opposite direction.

In one embodiment, the method also comprises receiving input signals indicating a detected direction of user movement along a second touch-sensitive user control disposed on a housing of an image-capturing device, and generating control signals to control a second image-capturing function based on the input signals.

In one embodiment, generating control signals comprises generating control signals to control zoom responsive to receiving input signals from the first touch-sensitive user control, and generating control signals to control focus responsive to receiving input signals from the second touch-sensitive user control.

In another embodiment, generating the control signals to control a second image-capturing function comprises generating control signals to control an exposure level based on the input signals indicating a direction of user movement along one of the first and second touch-sensitive user controls.

In one embodiment, the method comprises forming the first touch-sensitive user control is formed in a substantially circular shape, and positioning the first touch-sensitive user control to substantially surround a lens assembly.

### BRIEF DESCRIPTION OF THE DRAWINGS

FIGS. 1A-1B are perspective views that illustrate a camera configured to allow a user to manually control its functions according to one embodiment of the present invention.

FIG. 2 is a block diagram illustrating some of the components of a camera configured to function according to one embodiment of the present invention.

FIG. 3 is a block diagram illustrating some of the components of a camera-equipped wireless communications device configured to function according to one embodiment of the present invention.

FIG. 4 is a perspective view of a camera-equipped wireless communications device configured to function according to one embodiment of the present invention.

### DETAILED DESCRIPTION

The present invention provides a device capable of capturing images, such as a camera or a camera-equipped wireless communication device, which uses touch sensors to allow a user to manually control its zoom and focus functionality. Particularly, in one embodiment, a touch-sensitive zoom control is circularly shaped and disposed on the housing such that it substantially surrounds a camera lens. A user may move a finger around this sensor in both clockwise and counter-clockwise directions to manually control the zoom of the image-capturing device. Another, touch-sensitive focus control may be formed as an elongated strip, and may be disposed on another area of the device housing. The user may slide a finger back and forth along this touch-sensitive user control to manually control focus. Of course, the touch-sensitive user controls may be swapped. That is, the touch-sensitive zoom control may be formed as the elongated strip along which the user slides a finger, and the touch-sensitive focus control may be circularly shaped and disposed on the housing such that it substantially surrounds the camera lens.

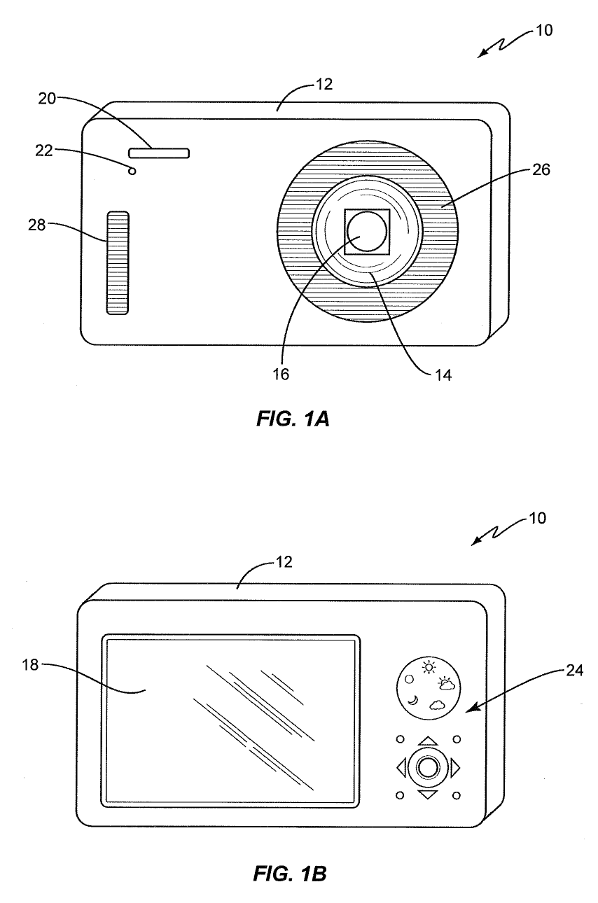

Turning now to the drawings, FIGS. 1A and 1B illustrate perspective views of a front face (FIG. 1A) and an opposing back face (FIG. 1B) of a camera 10 configured according to one embodiment of the present invention. As seen in the figures and as described by the specification, the camera 10 comprises a digital camera; however, this is for illustrative purposes only and the present invention is not limited to use solely in digital cameras. In fact, the present invention is not limited to use in cameras. Those skilled in the art should appreciate that the present invention may be employed by any type of device known in the art that is capable of capturing still images and/or video of a subject. Such devices include cameras, but also include cellular telephones, Personal Digital Assistants (PDAs), satellite telephones, suitably-equipped computing devices, and the like.

Camera 10 comprises a housing 12, a lens assembly 14, a display 18, a flash device 20, a light sensor 22, and a user interface 24. The lens assembly 14 comprises one or more lenses 16 that collects and focuses light onto an image sensor (not shown). The image sensor may be, for example, any conventional image sensor, such as a charge-coupled device (CCD) or a complementary metal oxide semiconductor (CMOS) image sensor. The image sensor captures the images formed by the light as raw image data, and forwards that raw image data to an image processor (not shown). The image processor then processes the raw image data for subsequent storage in memory, or for output to a display 18.

In this embodiment, the lens assembly 14 has a telescoping structure that allows the lens assembly 14 to retract into, and extend out of, the camera housing 12. Generally, such movement of a lens assembly increases and decreases optical zoom. The one or more focusing lenses 16, which may be structured as an array of optical lenses, for example, may also be movable independently of the lens assembly 14 structure. Movement of the focusing lenses 16 may be used to alter focus. As described in more detail below, the present invention may be used by an operator to manually control the movement of one or both of the lens assembly 14 and the focusing lenses 16 to alter the zoom and/or the focus of the camera 10.

Display 18 may comprise, for example, a Liquid Crystal Display (LCD) that allows a user of camera 10 to preview captured images, video, and view menu options and other information. In many cases, the display 18 also functions as a viewfinder to permit the user to view the subject of an image before capturing the image. Flash device 20 and light sensor 22 are disposed on the front face of camera 10. As is known in the art, the light sensor 22 measures the amount of ambient light. Based on that measurement, the camera 10 may generate one or more control signals to activate flash device 22 to provide additional illumination.

The user interface (UI) 24 is disposed on the back face of camera 10 and includes a variety of manual controls. As seen in the embodiment of FIG. 1B, the controls may include navigation controls to allow a user to manually navigate and select displayed menu options, and one or more selector switches and buttons that permit the user to manually specify ambient lighting conditions. Although not specifically shown, other types of controls that accept user input are also possible. For example, some cameras will also include a keypad to receive alphanumeric data from a user, a spring-loaded switch to turn the camera on and off, and a plurality of contact switches that allow a user to manually adjust the zoom and/or focus.

However, for conventional cameras, such manual controls can be problematic. Particularly, these controls typically extend through openings in the housing 12 and contact a signal path on a printed circuit board (PCB). Dirt and other debris may enter the camera housing 12 through these openings. Further, such mechanical controls may wear quickly. Additionally, these types of controls may impact internal circuit design because the components and signal paths that carry and process their resultant signals must be located near the controls. Given that user controls are typically positioned on the housing 12 to facilitate user access, there is little room for deviation in the internal circuit design.

The present invention, however, addresses such problems. Particularly, the UI 20 of camera 10 also includes one or more touch-sensitive user controls 26, 28 disposed on the housing 12 (FIG. 1A). The touch-sensitive user controls 26, 28 may comprise, for example, arrays of capacitive sensors that generate signals to control a feature of the camera 10 responsive to sensing the user's touch. Although the present invention is not limited to these types of sensors, one example of a suitable capacitive sensor that may be employed by the present invention is any capacitive sensor in the CAPSENSE family of sensors manufactured by CYPRESS SEMICONDUCTOR CORPORATION.

Capacitive sensors are well known in the art. However, for clarity, a brief description is included here. Generally, capacitive sensors, such as the CAPSENSE sensors, are formed as an array of switched capacitors. A voltage is applied through the sensor array. The sensor array detects changes in the applied voltage as the user moves a finger, for example, over the array and then sends the detected voltages to the comparator. The comparator compares the detected voltages to a reference value and, based on the comparison, outputs an appropriate signal that is processed to determine the sensors' status.

As seen in FIGS. 1A-1B, there are two independent touch-sensitive user controls 26, 28. A first touch-sensitive user control 26 is formed in a substantially circular shape, and disposed on housing 12 such that it substantially surrounds the lens assembly 14. Such a circular touch-sensitive sensor 26 may be manufactured, for example, by wrapping the switched capacitor array around 360 degrees. In operation, the user slides his or her finger around the touch-sensitive user control 26 in clockwise and counterclockwise directions. The array outputs different voltages as a signal depending on the detected direction of the user's finger.

A second touch-sensitive user control 28 is also disposed on the front face of housing 12. The second touch-sensitive user control 28 is formed as an elongated strip over which the user may move his or her-finger, for example. As with the first user control 26, the second user control 28 detects which direction that the user is moving his or her finger along user control 26, and outputs an appropriate voltage.

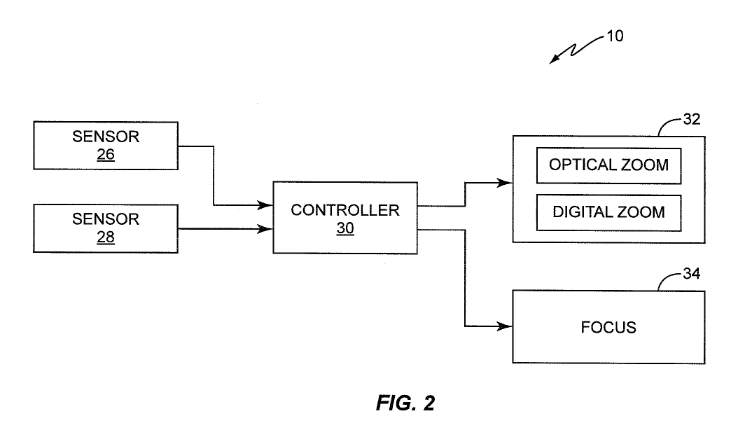

FIG. 2 is a block diagram that illustrates some of the component parts of camera 10, and how those components interact to control the functions of camera 10 responsive to the detected user touch on one or both of the touch-sensitive user controls 26, 28.

As seen in FIG. 2, the camera 10 comprises a controller 30 that interconnects the touch-sensitive user controls 26, 28 to zoom and focus mechanisms 32, 34 contained within the camera 10. The zoom and/or focus mechanisms 32, 34 may be, for example, hardware and/or software functions that are already included in camera 10. As one or both of the touch-sensitive user controls 26, 28 detects user movement along the user controls 26, 28, they output their respective comparator results to the controller 30. Controller 30 is configured to interpret these signals, and to generate control signals to control one or both of the zoom mechanism 32 and the focus mechanism 34 based on the received signals.

FIG. 2 illustrates the zoom mechanism 32 as having two components—optical zoom and digital zoom. Regardless of the type of zoom, the zoom mechanism 32 is controlled according to the signals output by the first touch-sensitive user control 26. For optical zoom, when a user slides a finger in a clockwise direction around touch-sensitive user control 26, the controller 30 could generate a control signal with a first value to extend the telescoping lens assembly 14 out of the housing 12 to increase the zoom. If the user slides a finger around the sensor 26 in a counter-clockwise direction, however, the controller 30 could generate the control signal with a second value to retract the telescoping lens assembly 14 into the housing 12 to decrease the zoom.

Not all image-capturing devices, however, will employ such telescoping lens assemblies to effect optical zoom. In some cases, zoom may be effected by altering one or more lenses within the housing 12. In these cases, the lens assembly might not extend out of and retract into the housing 12, but instead, might include one or more lenses that slide axially within the housing 12. In these cases, the zoom mechanism 32 may be controlled according to the signals output by the first touch-sensitive user control 26. Therefore, when the user slides a finger clockwise around touch-sensitive user control 26, the controller 30 could generate a control signal with a first value to slide one or more lenses axially in a first direction within the housing 12 to increase the zoom. Conversely, sliding a finger around the control in a counter-clockwise direction might cause the controller 30 to generate the control signal with a second value to slide the one or more lenses axially in a second, opposing direction within the housing 12 to decrease the zoom.

For digital zoom, the controller 30 could generate appropriate control signals responsive to the touch-sensitive user control 26 to cause an image processor, for example, to process pixels accordingly. Specifically, the first control signal may be generated to cause the image processor to apply digital zoom techniques to enlarge an image to be captured, while the second control signal may be generated to control the image processor to apply digital zoom techniques to reduce the image to be captured.

It should be noted that in some embodiments, the controller 30 may be configured to effect both the optical zoom and the digital zoom of a camera 10 responsive to the output of the first touch-sensitive user control 26. In such embodiments, the controller 30 could first alter the optical zoom of camera 10 responsive to the detected movement of the user's finger around touch-sensitive user control 26. Once the optical zoom capability of camera 10 has been reached or exceeded, the controller 30 could then control the digital zoom capabilities. In a similar manner, the controller 30 could be configured to first decrease the digital zoom responsive to the detected movement of the user's finger around touch-sensitive user control 26. Once the digital zoom is no longer being used, the controller 30 could then decrease the optical zoom. Although possible, there is no requirement that the user specify which particular zoom function—optical or digital—should be changed.

The focus mechanism 34 is controlled according to the signals output by the elongated second touch-sensitive user control 28. When a user moves a finger in a first direction (e.g., ‘up’), the controller 30 could generate a control signal to move one or more of the lenses 14 to alter focus. When the user moves the finger along the second touch-sensitive user control 28 in a second direction (e.g., down), the controller could generate another control signal to move the lenses 16 in an opposite direction to alter focus.

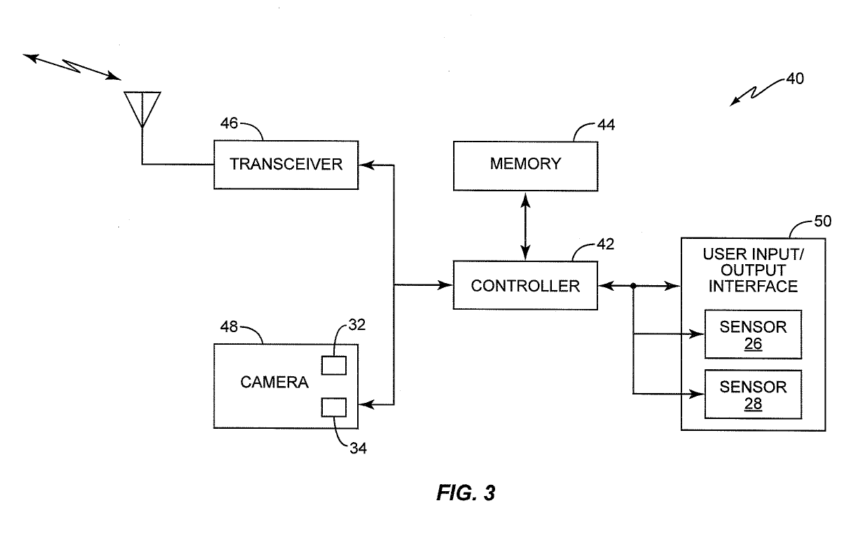

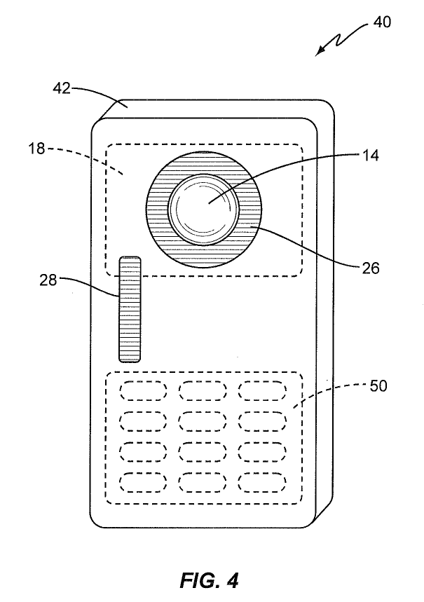

As previously stated, those skilled in the art should realize that the present invention may be employed on devices other than a camera 10. As seen in FIGS. 3 and 4, for example, the present invention may also be used on a camera-equipped wireless communication device, such as a camera-equipped cellular telephone 40.

FIG. 3 shows some of the components of a camera-equipped cellular telephone 40 configured according to one embodiment of the present invention. As seen in FIG. 3, the camera-equipped cellular telephone 40 comprises a controller 42 that interconnects a memory 44, a transceiver 46, a camera 48, and a user interface (UI) 50. The UI 50 includes the touch-sensitive user controls 26, 28 that are used to detect the user's touch, and to control both the zoom and focus mechanisms 32, 34 of camera 10 as previously described. However, in some embodiments, the camera 48 and the touch-sensitive user controls 26, 28 may be part of a camera interface module. Camera interface modules generally contain the circuitry and components that are required to capture images and/or video, and are usually mated with a cellular telephone during manufacture.

FIG. 4 is a perspective view showing a rear face of the camera-equipped cellular telephone 40. In FIG. 4, the first touch-sensitive user control 26 is disposed around the lens 14. Because the lens 14 of a camera-equipped cellular telephone 40 is typically very small, the first touch-sensitive user control 26 may be enlarged to allow the user to easily locate and operate the touch-sensitive user control 26. The second touch-sensitive user control 28 is disposed near an edge of the rear face of device 40. The user may operate the first and second touch-sensitive user controls 26, 28 as previously described to adjust one or both of the zoom and focus functions provided by the camera-equipped cellular telephone 40.

The present invention may, of course, be carried out in other ways than those specifically set forth herein without departing from essential characteristics of the invention. For example, the first and second touch-sensitive user controls 26, 28 may be placed anywhere on the housing of camera 10 or the camera-equipped cellular telephone 40. Further, there is no requirement that the touch-sensitive user controls 26, 28 be capacitive sensors. Other types of touch-sensitive sensors and detectors may also be used.

Additionally, the first and second touch-sensitive user controls are described herein as being used to control the zoom and focus functions of the camera 10. However, the present invention is not so limited. In one embodiment, for example, a touch-sensitive user control may be used to generate input signals to control an exposure level. Particularly, the second touch-sensitive user control, or another touch-sensitive user control, could be configured to generate input signals having different values responsive to detecting the user's finger sliding along the control. The controller could then generate the appropriate control signals to control the exposure levels for the camera 10 responsive to the input signals. Other functions and features of camera 10 may also be controlled using touch-sensitive user controls.

Therefore, the present embodiments are to be considered in all respects as illustrative and not restrictive, and all changes coming within the meaning and equivalency range of the appended claims are intended to be embraced therein.

What is claimed is:

1. An image-capturing device comprising:
a housing;
a lens assembly;
a first touch-sensitive user control disposed on the housing and configured to generate input signals based on a detected direction of user movement along the first touch-sensitive user control; and
a controller communicatively connected to the first touch-sensitive user control and configured to control a first image-capturing function based on the input signals.

2. The image-capturing device of claim 1 wherein the controller is configured to increase zoom responsive to the first touch-sensitive user control detecting the user moving in a first direction, and to decrease zoom responsive to the first touch-sensitive user control detecting the user moving in a second, opposite direction.

3. The image capturing device of claim 2 wherein the controller is configured to extend the lens assembly out of the housing to increase optical zoom, and to retract the lens assembly into the housing to decrease optical zoom, responsive to the input signals.

4. The image-capturing device of claim 2 further comprising an image processor communicatively connected to the controller, and configured to increase and decrease digital zoom responsive to the first touch-sensitive user control detecting the user moving in the first and second directions, respectively.

5. The image-capturing device of claim 1 wherein the first touch-sensitive user control is configured to generate the input signals to cause the controller to alter a focus of the lens assembly responsive to detecting the user moving in a first direction, and a second, opposite direction.

6. The image-capturing device of claim 1 further comprising a second touch-sensitive user control disposed on the housing and configured to generate input signals based on a detected direction of user movement along the second touch-sensitive user control.

7. The image-capturing device of claim 6 wherein the controller is further configured to control a second image-capturing function responsive to the input signals generated by the second-touch sensitive user control.

8. The image-capturing device of claim 6 wherein the controller is further configured to:
generate control signals to control a zoom function of the image-capturing device responsive to receiving input signals from the first touch-sensitive user control; and
generate control signals to control a focus of the image-capturing device responsive to receiving input signals from the second touch-sensitive user control.

9. The method of claim 6 wherein the controller is further configured to generate control signals to control an exposure level function of the image-capturing device responsive to receiving input signals from one of the first and second touch-sensitive user controls.

10. The image-capturing device of claim 1 wherein the first touch-sensitive user control is formed in a substantially circular shape, and is positioned on the housing such that it substantially surrounds the lens assembly.

11. The image-capturing device of claim 10 wherein the first touch-sensitive user control comprises a capacitive sensor device and is configured to detect the user moving around the control in a clockwise direction and a counterclockwise direction.

12. The image-capturing device of claim 10 wherein the second touch-sensitive user control comprises a capacitive sensor device formed as an elongated strip, and is configured to detect the user moving back and forth along the control.

13. A method of controlling an image-capturing function, the method comprising:
receiving input signals indicating a detected direction of user movement along a first touch-sensitive user control disposed on a housing of an image-capturing device;
generating control signals to control a first image-capturing function based on the input signals.

14. The method of claim 13 wherein generating control signals comprises:
generating control signals to increase optical zoom responsive to the first touch-sensitive user control detecting the user moving in a first direction; and
generating control signals to decrease optical zoom responsive to the first touch-sensitive user control detecting the user moving in a second, opposite direction.

15. The method of claim 13 wherein generating control signals comprises:
generating control signals to increase digital zoom responsive to the first touch-sensitive user control detecting the user moving in a first direction; and
generating control signals to decrease digital zoom responsive to the first touch-sensitive user control detecting the user moving in a second, opposite direction.

16. The method of claim 13 wherein generating control signals comprises generating the control signals to alter a focus responsive to the first touch-sensitive user control detecting the user moving in a first direction and a second, opposite direction.

17. The method of claim 13 further comprising:
receiving input signals indicating a detected direction of user movement along a second touch-sensitive user control disposed on a housing of an image-capturing device; and
generating control signals to control a second image-capturing function based on the input signals.

18. The method of claim 17 wherein generating control signals comprises:
generating control signals to control zoom responsive to receiving input signals from the first touch-sensitive user control; and
generating control signals to control focus responsive to receiving input signals from the second touch-sensitive user control.

19. The method of claim 17 wherein generating control signals to control a second image-capturing function comprises generating control signals to control an exposure level based on the input signals indicating a direction of user movement along one of the first and second touch-sensitive user controls.

20. The method of claim 13 further-comprising forming the first touch-sensitive user control is formed in a substantially circular shape, and positioning the first touch-sensitive user control to substantially surround a lens assembly.
